(19) United States
(12) Patent Application Publication
(10) Pub. No.: US 2022/0361446 A1
(43) Pub. Date: Nov. 17, 2022

(54) BUDDY'S FUR FORK

(71) Applicant: LINDA ANNE MCFAIN, POCAHONTAS, IL (US)

(72) Inventor: LINDA ANNE MCFAIN, POCAHONTAS, IL (US)

(21) Appl. No.: 17/317,826

(22) Filed: May 11, 2021

(51) Int. Cl. A01K 13/00

(52) U.S. Cl. CPC A01K 13/002; A47G 21/023

(57) ABSTRACT

Fork for the Treatment of Matted Fur is a hair removal tool for pet hair cleaning. The fork is similar in fashion to a household eating utensil and is designed in a manner to remove tangled and otherwise unwanted hair from your pet's coat. The tool has proven to be successful in a wide range of pet hair types for hair removal applications. Cleaning the tool is simple via manual removal of collected hair from the tongs of the fork.

### BACKGROUND

The Fork For The Removal of Matted Fur serves to be a solution to remove fur balls from felines. Previous combs and brushes are not able to remove established fur balls quickly and effortlessly to avoid pain and distress to cats. The thin rakes of pet brushes only touch the surface hair. The Fork For The Removal of Matted Fur is small, but strong to allow it to penetrate deep along the scalp and grab small sections of matted fur, thus allowing the matted fur to disintegrate and be pulled out without harming the pet.

### BRIEF SUMMARY

The Fork for The Removal of Matted Fur will dig down deep along the scalp of the pet and puncture right through established fur balls. This allows the fur balls to separate into smaller sections and easily be pulled from the scalp. Previous combs and brushes will not work on pets with soft, plush hair.

An example would be the Himalayan breed feline. Their fur is very soft and mattes close to the body of the animal. The Fork For The Removal of Matted Fur is designed to run through the fur and cut into the fur balls to separate the matted fur and thus thin the fur balls for easy matted hair removal.

### BRIEF DESCRIPTION OF DRAWING

FIG. 1 depicts a hand sketched concept in an isometric view of the present invention.

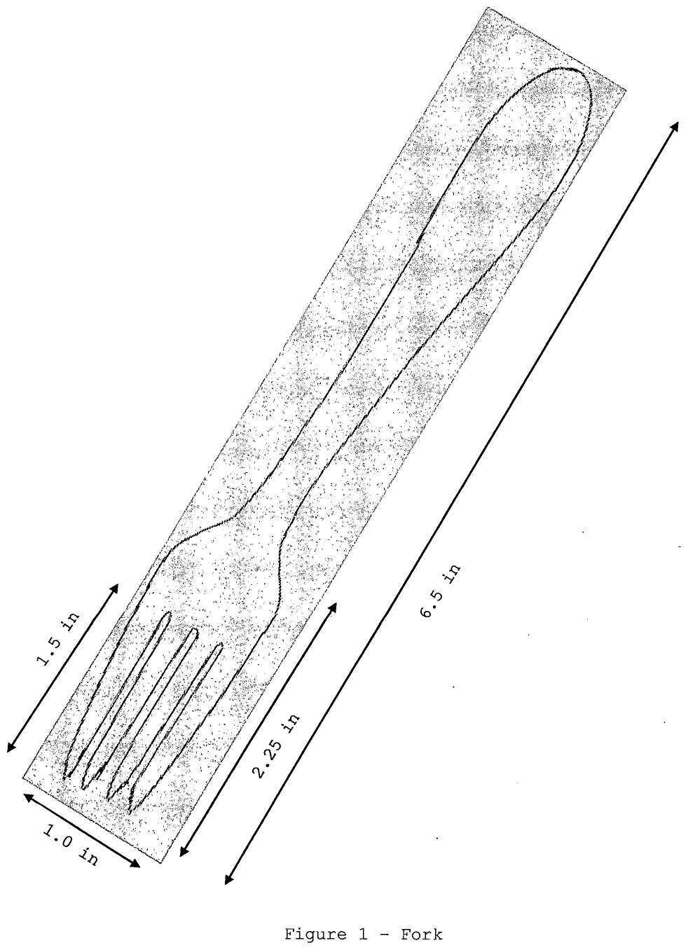

### DETAILED DESCRIPTION OF DRAWING

The Fork for The Removal of Matted Fur is simply a remake or a new use for the household table fork. The fork needs to be made out of a metal composition with teeth that are pointed and not dull. The fork will be no longer than 7″ and contain a minimum of 4 teeth, each being no longer than 1.5″. Curvature of planar deviation is acceptable along the length of the present invention. A material well suited for the composition would be stainless steel for its sustainability and ease of manufacture via press forming operations. Please see the attached drawing sheet.

1. Fork for the Removal of Matted Fur claims to reinvent a use for a fork with straight prongs.

2. This device as noted in claim 1 works for removal of matted fur.

3. This apparatus as noted in claim 1 discovers a new process or method by which you can remove matted fur and operates to perform its intended purpose.
